(19) United States
(12) Patent Application Publication
(10) Pub. No.: US 2006/0277275 A1
(43) Pub. Date: Dec. 7, 2006

(54) DYNAMIC MANAGEMENT OF COMMUNICATION PORTS, DEVICES, AND LOGICAL CONNECTIONS

(76) Inventor: Eric Florent Glaenzer, Mountain View, CA (US)

Correspondence Address: WALSTEIN BENNETT SMITH III, P. O. BOX 1668, GEORGETOWN, TX, 78628, US

(21) Appl. No.: 11/278,139

(22) Filed: Mar. 30, 2006

Related U.S. Application Data
(60) Provisional application No. 60/689,584, filed on Jun. 10, 2005.
(60) Provisional application No. 60/686,072, filed on May 31, 2005.
(60) Provisional application No. 60/667,629, filed on Apr. 2, 2005.

(51) Int. Cl. G06F 15/16

(52) U.S. Cl. 709/219

(57) ABSTRACT

A Connection Manager is selectively invoked when an application on a computing host opens a designated gateway communications port. Any application that opens the gateway port and which has a preexisting entry in a special applications database will result in the appropriate target communications port being transparently selected, attributed, and configured and the application becoming automatically connected to the desired target device. Connections may be wired or wireless. The Connection Manager provides a straightforward and uniform way to automatically manage (including configuration and reconfiguration) ports and devices for communication applications executing on the computing host.

### CROSS REFERENCE TO RELATED APPLICATIONS

Priority benefit claims for this application are made in the accompanying application transmittal or Application Data Sheet (if any). To the extent permitted by the type of the instant application, this application incorporates by reference for all purposes the following applications, which are all owned by the owner of the instant application:
U.S. Provisional Application Ser. No. 60/667,629, (Docket No. SC.2005.40) filed Apr. 2, 2005, by Eric Glaenzer, and entitled Dynamic Management of COM Ports, Devices, and Logical Connections;
U.S. Provisional Application Ser. No. 60/686,072, (Docket No. SC.2005.41) filed May 31, 2005, by Eric Glaenzer, and entitled Dynamic Management of COM Ports, Devices, and Logical Connections; and
U.S. Provisional Application Ser. No. 60/689,584, (Docket No. SC.2005.42) filed Jun. 10, 2005, by Eric Glaenzer, and entitled Dynamic Management of COM Ports, Devices, and Logical Connections.

### COPYRIGHT NOTICE

A portion of the disclosure of this patent document contains material which is subject to copyright protection in various jurisdictions. The copyright owner has no objection to the facsimile reproduction by anyone of the patent document or the patent disclosure, as it appears in the official patent file or records, but otherwise reserves all copyright rights whatsoever.

### BACKGROUND

1. Field

Advancements in establishing one or more communications links between one or more software applications and one or more communications devices are needed to provide improvements in performance, efficiency, and utility of use.

2. Related Art

Unless expressly identified as being publicly or well known, mention herein of techniques and concepts, including for context, definitions, or comparison purposes, should not be construed as an admission that such techniques and concepts are previously publicly known or otherwise part of the prior art. All references cited herein (if any), including patents, patent applications, and publications, are hereby incorporated by reference in their entireties, whether specifically incorporated or not, for all purposes. Nothing herein is to be construed as an admission that any of the references are pertinent prior art, nor does it constitute any admission as to the contents or date of actual publication of these documents.

### SUMMARY

The invention may be implemented in numerous ways, including as a process, an article of manufacture, an apparatus, a system, a composition of matter, and a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention. The Detailed Description provides an exposition of one or more embodiments of the invention that enable improvements in performance, efficiency, and utility of use in the field identified above. The Detailed Description includes an Introduction to facilitate the more rapid understanding of the remainder of the Detailed Description. The Introduction includes Illustrative Combinations that tersely summarize illustrative systems and methods in accordance with the concepts taught herein. As is discussed in more detail in the Conclusions, the invention encompasses all possible modifications and variations within the scope of the issued claims, which are appended to the very end of the issued patent.

A “Connection Manager,” as that term is used herein, is a new communication subsystem for software applications executing on a host computing system, and is the basis for systems, devices, and methods disclosed below. Illustrative host computing systems include, but are not limited to, a Smartphone, a PDA, a handheld computer, a laptop computer, a desktop or tower computer, and a computer server. Illustrative components of a host computing systems generally include but are not limited to a processor, a main memory for program execution, I/O including communication and/or networking ports, system software including an operating system (OS), one or more instances of application software, and one or more types of mass storage for the software including but not limited to disk storage and/or flash memory. In certain embodiments the OS is Windows XP. In accordance with the overall application specific nature of the host computer, other OS may be used, including but not limited to Windows Mobile or other Windows variants, Palm OS variants, Symbian OS variants, or Linux/Unix variants.

### BRIEF DESCRIPTION OF DRAWINGS

FIG. 1 illustrates a Connection Manager enabled system 1000, showing the relationship of applications, Connection Manager mapped port 150, Connection Manager routines 120, Connection Manager Database 130, communications ports, and devices, in an exemplary embodiment.

FIG. 2A illustrates a control flow 2000 for the operation of the Connection Manager enabled system 1000 of FIG. 1, in an exemplary embodiment.

FIG. 2B illustrates an exemplary embodiment of “Apply Connection Policy” 2300, of FIG. 2A.

FIG. 2C illustrates an exemplary embodiment of “Apply Reconnection Policy” 2500, of FIG. 2A

FIG. 3 illustrates an exemplary embodiment of “CM DB” 130, of FIG. 1.

FIG. 4 details key components and relationships of another exemplary Connection Manager enabled system 4000.

FIG. 5 illustrates a control flow 5000 for the operation of the Connection Manager enabled system 4000 of FIG. 4.

### DETAILED DESCRIPTION

A detailed description of one or more embodiments of the invention is provided below along with accompanying figures that illustrate the principles of the invention. The invention is described in connection with the embodiments. It is well established that it is neither necessary, practical, or possible to exhaustively describe every embodiment of the invention. Thus the embodiments herein are understood to be merely illustrative, the invention is expressly not limited to or by any or all of the embodiments herein, and the invention encompasses numerous alternatives, modifications and equivalents. The existence of embodiments in some way distinct from other embodiments may be described by such adjectives as “notable”, “particular”, “some”, or equivalents thereof. All such similar characterizations should be considered to be interchangeable, being variously used to avoid monotony in the exposition and should not be construed as limiting the invention in any way or that the embodiments so labeled should be treated any differently than the other embodiments, as every embodiment described herein can be so characterized. Wherever multiple embodiments serve to illustrate variations in process, method, and/or program instruction features, other implementations are contemplated that in accordance with a predetermined or a dynamically determined criterion perform static and/or dynamic selection of one of a plurality of modes of operation corresponding respectively to a plurality of the multiple embodiments. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Introduction

This introduction is included only to facilitate the more rapid understanding of the Detailed Description. The invention is not limited to the concepts presented in the introduction, as the paragraphs of any introduction are necessarily an abridged view of the entire subject and are not meant to be an exhaustive or restrictive description. For example, the introduction that follows provides overview information limited by space and organization to only certain embodiments. There are in fact many other embodiments, including those to which claims will ultimately be drawn, which are discussed throughout the balance of the specification.

The Connection Manager is invoked whenever an application opens a designated gateway communications port. Any application that opens the gateway port and which has a preexisting entry in a special applications database will result in the appropriate target communications port being transparently selected, attributed, and configured and the application becoming automatically connected to the desired target device. Connections may be wired or wireless. Thus the Connection Manager provides an easy and uniform way for users to automatically manage (including configuration and reconfiguration) ports and devices for all their communication applications (including, but not limited to GSM applications).

Subsequent to being invoked and transparent to the application, the Connection Manager identifies each application and does a lookup in the applications database for a corresponding entry. Based on the corresponding entry, the Connection Manager implements a connection policy, also known as a connection scenario. In one connection policy embodiment, the Connection Manager automatically selects, attributes, and configures the target communication port for use with the target communication device and establishes and manages a logical connection (communications link) between the application and its respective target device. In a second connection policy embodiment, the Connection Manager gateway port is opened in a Server mode that does not itself initiate the connection but instead listens for an incoming connection from the target device.

Subsequent to a logical connection being established, if the target device disconnects, the Connection Manager implements a reconnection policy, also known as a reconnection scenario. In one reconnection policy embodiment, the reconnection policy is determined at least in part by the application database entry associated with the disconnected connection.

The Connection Manager is adapted to concurrently share the gateway port among multiple applications to multiple devices. In the absence of contention, the Connection Manager is further adapted to set up and manage concurrent connections and reconnections between multiple applications and their respective target devices. Multiple application database entries may map a common target port to respective different devices. Thus the Connection Manager is adapted to sequentially share the target port among the multiple applications to the multiple devices.

The Connection Manager maintains the applications database, which contains entries of software applications and respective target ports and devices connected via the ports. Entries are established in the applications database by way of a configuration process. In one configuration process embodiment, the configuration process is performed the first time an application opens the gateway port.

Instead of a specific target device, a “device discovery” option may be specified. This is particularly useful in the case of network-related ports, including, but not limited to wireless ports. A device discovery is performed and the user is prompted to choose the desired remote device from a list resulting from the discovery.

Device communication ports include, but are not limited to, TCP/IP ports and sockets, serial COM ports, parallel LPT ports, wireless ports, USB ports, and Firewire ports. Wireless ports include, but are not limited to, ports compatible with the WiFi, Bluetooth, UWB, and ZigBee standards. Gateway communication ports include, but are not limited to, virtual communications ports and physical communications ports, including any of the previously itemized device ports.

Each physical communications port has associated input/output (I/O) hardware, including one or more I/O chips, and an associated software driver. In some port embodiments, access to the driver is managed by the host Operating System. Higher level software, such as the Connection Manager, communicates with each physical communication port via the port's corresponding software driver, which in turn communicates with the associated I/O hardware. A virtual communications port does not have directly associated hardware.

Illustrative Combinations

This introduction concludes with a collection of paragraphs that tersely summarize illustrative systems and methods in accordance with the concepts taught herein. Each of the paragraphs highlights various combinations of features using an informal pseudo-claim format. These compressed descriptions are not meant to be mutually exclusive, exhaustive, or restrictive and the invention is not limited to these highlighted combinations. As is discussed in more detail in the Conclusion section, the invention encompasses all possible modifications and variations within the scope of the issued claims, which are appended to the very end of the patent.

A method comprising: automatically detecting and identifying each application initiating communications and configuring and managing each physical communication port associated with each identified application. The foregoing method wherein the initiating communications action includes opening a select communications port. The foregoing method wherein the select communications port is logically mapped onto a remote device. The foregoing method wherein the remote device onto which the select communications port is mapped is a function of the application that opened the select communications port. The foregoing method further including connecting any one of multiple applications to any one of multiple devices via the opening of the select communications port. The foregoing method wherein opening the select communications port results in execution of a predetermined connection policy. The foregoing method wherein a predetermined reconnection policy is executed upon disconnection of the remote device. The foregoing method wherein the select communications port is legacy serial port compatible.

A method to manage communications between applications, communication ports, and remote devices, the method comprising: intercepting each application attempt to open at least a select one of the communication ports, each intercepted application corresponding to a known application being identified as a respective recognized application and having an associated physical communication port and a preferred remote device, each intercepted application not corresponding to a known application being identified as an unrecognized application, subsequent to a port opening attempt by a recognized application configuring and managing the associated port and logically connecting the recognized application to the preferred remote device via the associated port, and subsequent to a port opening attempt by an unrecognized application logically connecting the unrecognized application to the application specified communication port and thereby to whatever remote device is connected thereto.

A method to establish a communications link between at least one application and at least one communications device, the method comprising: establishing a database of known applications and associated communications devices and ports; detecting an application attempting to initiate communications; transparent to the application, identifying the application, configuring and managing the associated communication port, and establishing a logical connection between the application and the associated device.

A system, comprising: opening by applications of a shared gateway com port that communicates with a connection management subsystem having an associated com port management database; each application opening the virtual com port causes a lookup in the database; subsequently when the lookup result returns an entry, the connection manager configures the physical port and establishes a logical connection between the application and the device, via the physical port. The foregoing system, wherein the lookup uses a search key that includes an application identifier. The foregoing system, wherein if no entry is returned by the lookup, the connection manager attempts to create a new entry. The foregoing system, wherein the new entry is created with user participation. The foregoing system, wherein database entries include information about the desired physical communications device, the physical port the device is connected to, and how to configure the physical port. The foregoing system, wherein the gateway port has one type of the types including virtual port type and physical port type. The foregoing system wherein the gateway port has one type of the types including legacy serial port type, USB port type, and Firewire port type.

Particular Embodiments

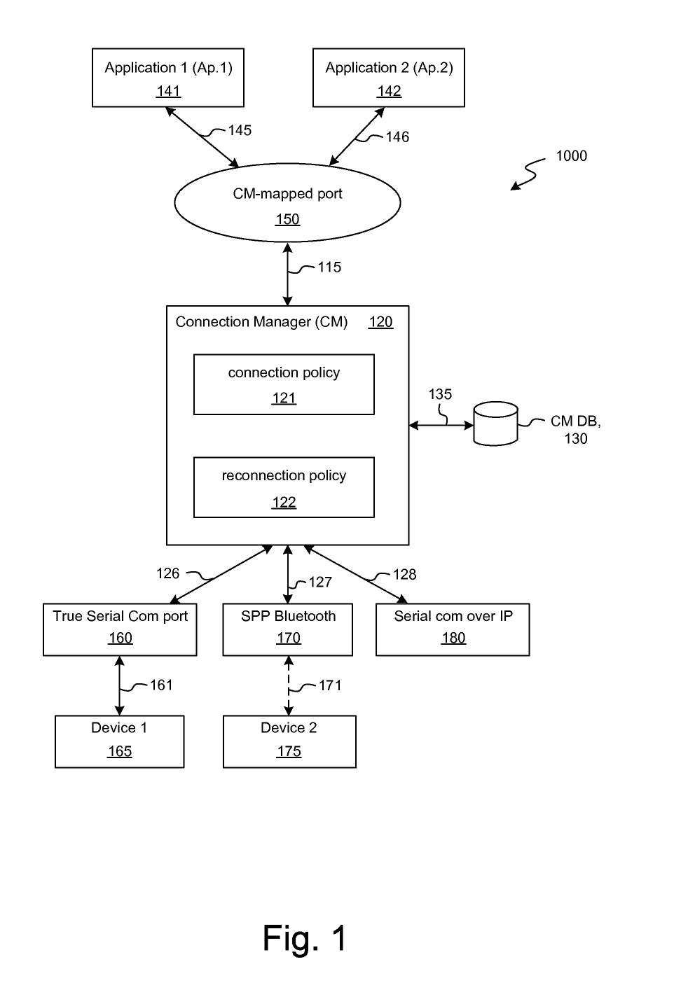

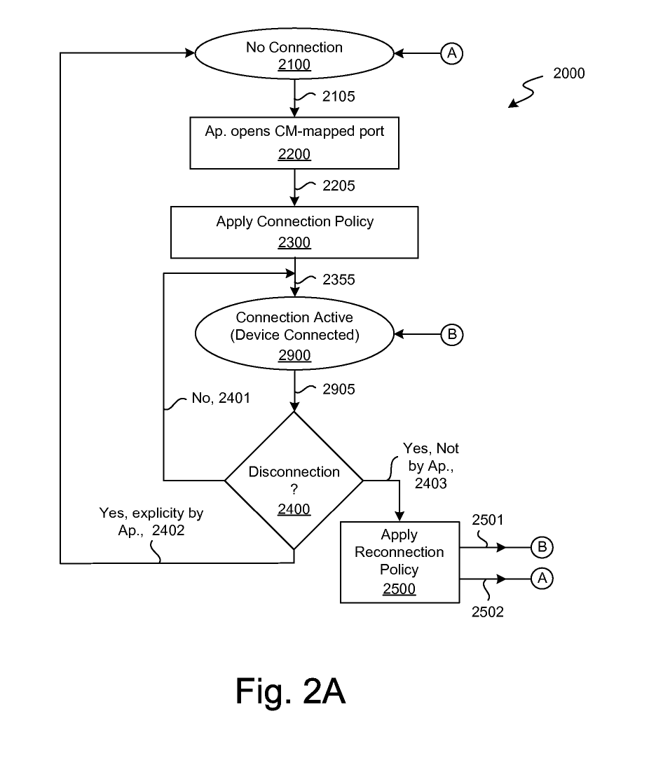

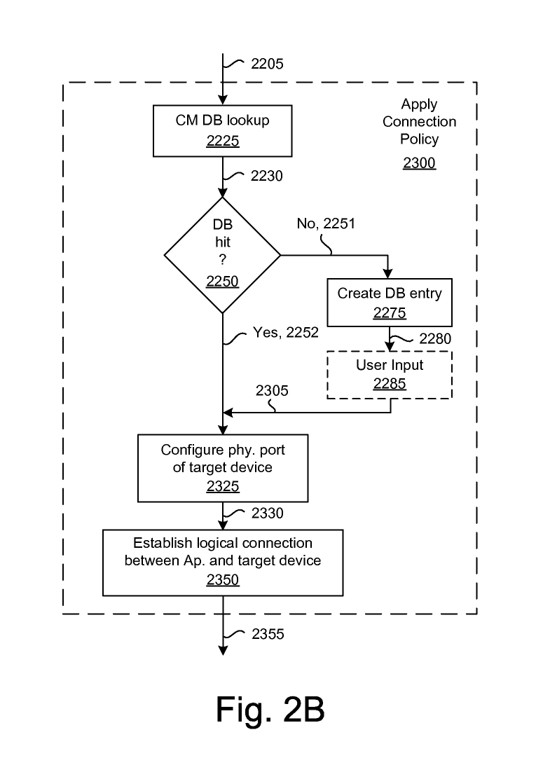

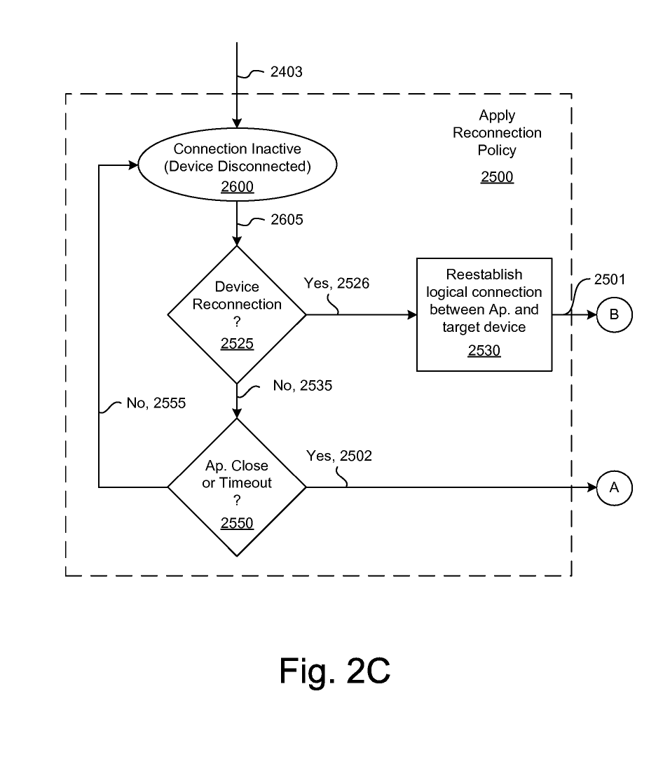

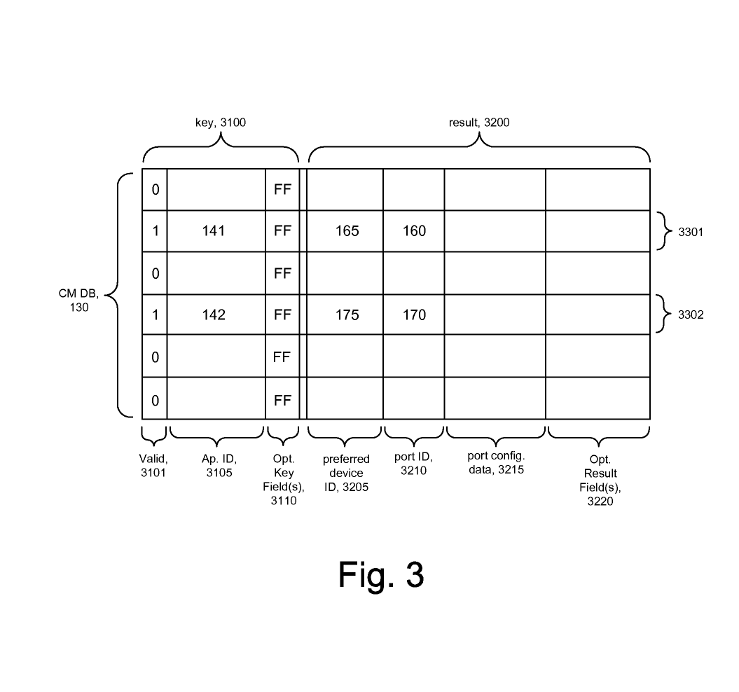

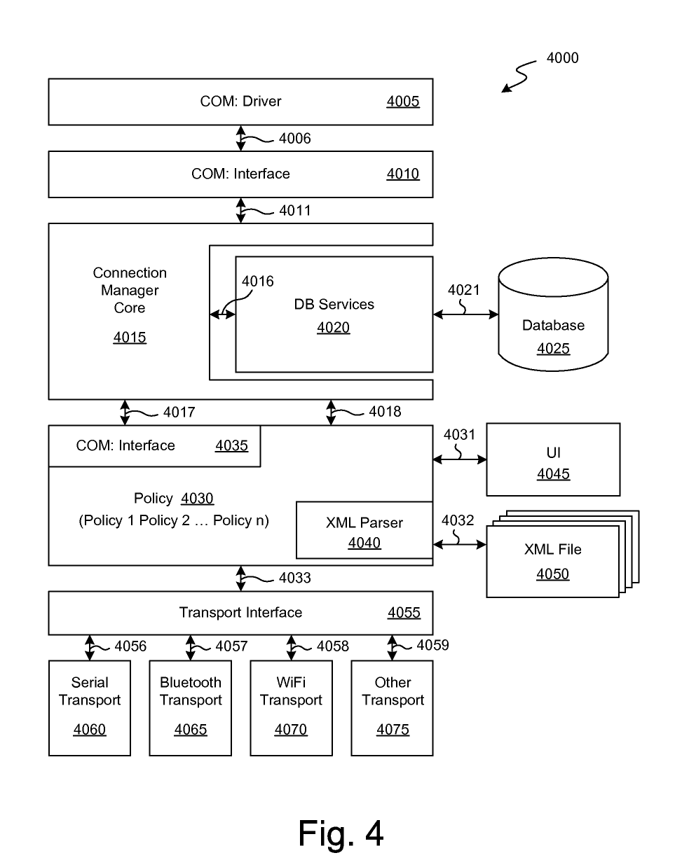

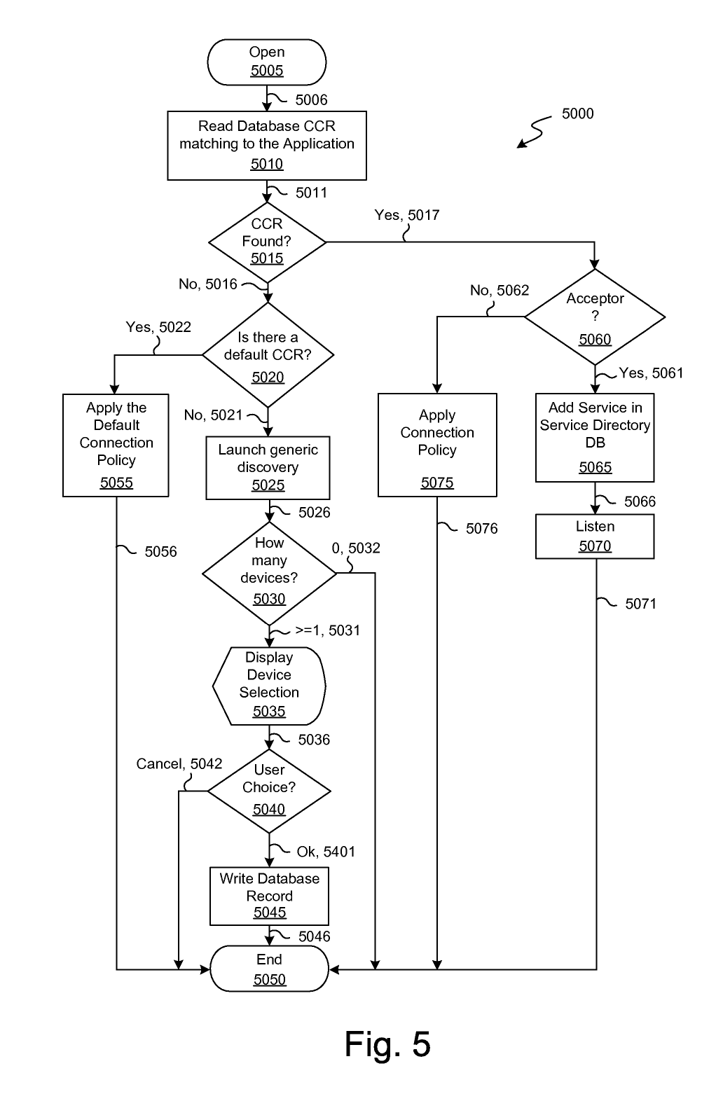

FIG. 1 illustrates a Connection Manager enabled system 1000, showing the relationship of applications, Connection Manager mapped port 150, Connection Manager routines 120, Connection Manager Database 130, communications ports, and devices, in an exemplary embodiment. FIG. 2A illustrates a control flow 2000 for the operation of the Connection Manager enabled system 1000 of FIG. 1, in an exemplary embodiment. FIG. 2B illustrates an exemplary embodiment of “Apply Connection Policy” 2300, of FIG. 2A. FIG. 2C illustrates an exemplary embodiment of “Apply Reconnection Policy” 2500, of FIG. 2A. FIG. 3 illustrates an exemplary embodiment of “CM DB” 130, of FIG. 1. FIG. 4 details key components and relationships of another exemplary Connection Manager enabled system 4000. FIG. 5 illustrates a control flow 5000 for the operation of the Connection Manager enabled system 4000 of FIG. 4.

The Connection Manager is transport-type and communication-stack-provider agnostic. It provides a generic interface to software to communicate with remote devices whatever the technology or stack provider being used. It minimizes sensitivity to implementation differences. It guaranties a common communication behavior among the transport types and communication stacks. The Connection Manager provides virtual ports so applications can use its features without code change. The Connection Manager supports legacy software by offering a virtual serial COM port interface.

The Connection Manager defines the logic of connection, reconnection by Application. A Database is used to store connection and reconnection context. In certain embodiments, an XML file is used to define the connection and reconnection policy with great flexibility. The Connection Manager database contains connection parameters mapped by Application. When an application opens the Connection Manager COM port, the core of the Connection Manager searches through its database for the connection parameters for this specific application. Depending on the connection parameters, the Connection Manager will try to configure the connection either by using the stored information in the Database or by parsing the XML file associated to this application.

On remote device disconnects, the Connection Manager tries to reconnect to the remote device without the application been aware of an eventual disconnection. Depending on the type of connection policy used, a uniform and generic UI is used to setup user preferences for a particular connection. The UI is invoked by the Connection Manager where user choice is necessary. The Connection Manager configuration is setup by an external applet (or equivalent script file). The Connection Manager provides an extendable set of connection and reconnection policies.

In certain embodiments, the Connection Manager is mounted as built-in driver. In other embodiments, it is mounted as a plug-in. It is Driver Manager compatible. The Connection Manager is written in order to provide the maximum common code between targeted OS. It supports the Landscape mode for Windows Mobile in which one of two screen orientations are selected dynamically.

In certain embodiments, the Connection Manager is integral to the OS. In other embodiments, the Connection Manager is a modular component of the OS. Thus in some scenarios, the Connection Manager is distributed with the OS. In other scenarios the Connection Manager is a modular software component that can be bundled into specialty OS distributions, such as by a hardware platform vendor, an OEM, or a software vendor, to give several illustrative but not limiting examples. In still other scenarios the Connection Manager module can be distributed later either alone or in conjunction with other software, such later distributions including via physical distributions of media such as by floppy, flash-drive, CD-ROM, or DVD-ROM or via Internet downloads performed by or on behalf of an end user.

In certain embodiments, the Connection Manager Architecture is implemented using UML (Unified Modeling Language) to define and describe the Connection Manager main objects. In these embodiments the UML is used as a development tool to facilitate understanding and collaboration among developers.

In the Connection Manager enabled system 1000 of FIG. 1, the applications include, but are not limited to, Application 1 (Ap. 1) 141 and Application 2 (Ap. 2) 142. Ap. 1 and Ap. 2 selectively make calls to and otherwise communicate with CM-mapped port 150. These communications are respectively represented by couplings 145 and 146. Connection Manager 120 communicates with CM-mapped port 150 and CM DB 130 via respective couplings 115 and 135. Connection Manager (CM) routines 120 include, but are not limited to, Connection Policy 121 and Reconnection Policy 122. The communications ports include, but are not limited to, True Serial Com port 160, SPP Bluetooth port 170, and Serial com over IP 180. These ports are respectively coupled to the Connection Manager 120 via couplings 126, 127, and 128. The devices include, but are not limited to, Device 1 165 and Device 2 175. In the exemplary embodiment of FIG. 1, Device 1 is coupled to True Serial Com port 160 via coupling 161, while Device 2 is coupled to port SPP Bluetooth 170 via coupling 171.

Attention is now drawn to the abstracted control flow 2000 of FIG. 2A. Consider first the “No Connection” state 2100. An opening of the CM-mapped port 150 by an application (represented by transition 2105 and action 2200) results in application of the Connection Policy (represented by transition 2205 and action 2300) and subsequent transition 2355 to the “Connection Active” state 2900. Until a device disconnect is recognized (by way of transition 2905 and decision “Disconnection?” 2400), control flow remains (via looping back transition 2401) in the Connection Active state 2900. If the application explicitly instructs the Connection Manager to disconnect, then flow returns (via transition 2402) to the “No Connection” state 2100. If a device disconnect occurs in the absence of an explicit application instruction to disconnect, then flow follows transition 2402 to “Apply Reconnection Policy” action 2500. As a result of applying the Reconnection Policy, control flow returns either to “Connection Active” state 2900 via transition 2501 and drawing connector “B”, or flow returns to “No Connection” state 2100 via transition 2502 and drawing connector “A”.

The “Apply Connection Policy” control flow 2300 of FIG. 2B is but one exemplary embodiment of the Connection Policy routine 121 of FIG. 1A. Flow follows path 2205 to “CM DB lookup” action 2225. The lookup is then evaluated by following path 2230 to “DB hit?” decision 2250. If the lookup results in a miss, flow from “DB hit?” decision 2250 proceeds via path 2251 to “Create DB entry” action 2275. Flow follows path 2280 to optional “User Input” action 2285 and the follows path 2305 to action 2325. If instead of a miss, an entry corresponding to the application opening the CM-mapped port is found, then flow proceeds via path 2252 to “Configure physical Port of target device” action 2325. Flow then follows path 2230 to “Establish logical connection between Application and target device” action 2350, and exits the “Apply Connection Policy” action 2300 via path 2355.

The “Apply Reconnection Policy” control flow 2500 of FIG. 2C is but one exemplary embodiment of the Connection Policy routine 122 of FIG. 1A. A device disconnected timer is initialized and flow follows path 2403 to “Connection Inactive” state 2600. For any of a variety of reasons, in a mobile environment many disconnects of brief duration may occur (for example, due to unintended/unavoidable mechanical jostling or wireless signal interference/interruption). At the same time, it is desirable to avoid unnecessarily repeatedly incurring the significant overhead of establishing a connection (events 2200 and action 2300 of FIG. 2A). Accordingly, prior to bringing down (discarding) the logical connection, “Device Reconnection?” decision 2525 (entered via path 2605) evaluates whether a reconnection has occurred. If at decision 2525 a reconnection has occurred, path 2526 is followed to “Reestablish logical connection between Application and target device” action 2530. Flow then leaves the “Apply Reconnection Policy” action 2500 via path 2501 and drawing connector “B” to return to “Connection Active” state 2900 of FIG. 2A.

For reliable/predictable operation it is desirable to bring down the logical connection if the application is subsequently closed or the device is disconnected for a significant time interval. If at decision 2525 there has been no reconnection, “Application Close or Timeout?” decision 2550 is then evaluated. If at decision 2550 there has been no explicit device closing by the associated Application, and if a predefined timeout interval for the device disconnected timer has not yet elapsed, flow loops back to “Connection Inactive” state 2600 via path 2555 (and the sequential evaluations of decisions 2525 and 2550 are repeated as appropriate). However, if at decision 2550 there has been an explicit closing of the device by the application, or if the device disconnected timeout interval has elapsed, the flow leaves the “Apply Reconnection Policy” action 2500 via path 2502 and drawing connector “A” to return to “No Connection” state 2100 of FIG. 2A. Among the various embodiments envisioned for the “Apply Reconnection Policy” 2500 are respective embodiments with a zero timeout, a finite programmable timeout, a finite fixed timeout, and an infinite timeout.

In FIG. 3 details the fields for a number of entries in “CM DB” 130, of FIG. 1. The description here is of a basic illustrative embodiment. See the discussion of CCR fields later herein for features of more advanced embodiments. Each entry can be conceptually divided into a key portion 3100 and a result portion 3200. The key portion 3100 is sub-divided into a valid field 3101; an Application ID field 3105; and one or more optional additional key fields, collectively 3110. The result portion 3200 is sub-divided into a preferred device ID field 3205; a port ID field 3210; a port configuration data field 3215; and one or more optional additional result fields, collectively 3220. As shown, based on the valid field values, only entries 3501 and 3502 are valid (contain meaningful information). Entry 3301 corresponds to Application ID 141 (also known as Application 1 of FIG. 1) and entry 3202 corresponds to Application ID 142 (also known as Application 2 of FIG. 1).

When an application opens the CM-mapped port, the Connection Manager forms a search key using a set valid bit and the calling application's Application ID value. If there is only one valid result entry desired for each application, the bits of the search key corresponding to optional key field(s) 3110 are all set to one (hex FF, as illustrated). The optional key field(s) 3110 makes it possible for different entries to correspond to different/subsequent instances of the same application. The multiple entries are distinguished by the optional key field(s) 3110, using for example, sequential application instance identifiers or parameters passed from each application. If the optional key field(s) feature is never needed in a particular embodiment, the bits corresponding to the optional key field(s) 3110 could be omitted in both the search key and the key portion of the DB entries.

When Application 1 (ID 141) opens the CM-mapped gateway port 150, the Connection Manager applies the connection policy 121 in accordance with the control flow of “Apply Connection Policy” 2300. The connection policy uses the Application ID 141 of calling Application 1 to search the CM DB 130 and subsequently retrieves entry 3301. The Connection Manager parses the result portion 3200 of entry 3301. The Connection Manager then configures port 160 in accordance with the port configuration data field 3215 of entry 3301 and uses port 160 to connect Application 1 to preferred device 165.

Similarly, when Application 2 (ID 142) opens the CM-mapped gateway port 150, the Connection Manager applies the connection policy 121 in accordance with the control flow of “Apply Connection Policy” 2300. The connection policy uses the Application ID 142 of calling Application 2 to search the CM DB 130 and subsequently retrieves entry 3302. The Connection Manager parses the result portion 3200 of entry 3302. The Connection Manager then configures port 170 in accordance with the port configuration data field 3215 of entry 3302 and uses port 170 to connect Application 2 to preferred device 175.

FIG. 4 details key components and relationships of another exemplary Connection Manager enabled system 4000. FIG. 4 also provides additional detail over FIG. 1, particularly with respect to Connection Manager 120. Blocks 4010, 4015, 4020, 4030, 4035, 4040, 4055, 4060, 4065, 4070, and 4075, all of system 4000 of FIG. 4, conceptually correspond to functions found within the boundaries of Connection Manager 120 of system 1000 of FIG. 1. Block 4005 and Database 4025 of system 4000 of FIG. 4, respectively correspond generally to port 150 and CM DB 130 of system 1000 of FIG. 1.

COM Driver 4005 is coupled to Connection Manager Core 4015 via intermediate COM interface 4010 and associated communication paths 4006 and 4011. The Connection Manager Core 4015 interacts with Database 4025 via intermediate DB Services 4020 and associated communication paths 4016 and 4021. Connection Manager Policy block 4030, comprises a plurality of processes 1 through n, n being determined by the requirements of each particular implementation. Policy block 4030 communicates with the Connection Manager Core 4015 directly via communication path 4018 and via COM: Interface 4035 and communication path 4017. Policy block 4030 communicates with User Interface (UI) 4045 via communication path 4031. Policy block 4030 communicates with XML File 4050 via XML Parser 4040 and communication path 4032. Policy block 4030 communicates with a plurality of transports via path 4033 and Transport Interface 4055, including Serial Transport 4050 (via communication path 4056), Bluetooth Transport 4065 (via communication path 4057), WiFi Transport 4070 (via communication path 4058), and Other Transport 4075 (via communication path 4059).

FIG. 5 illustrates a control flow embodiment 5000 providing connection operation details of the Connection Manager enabled system 4000 of FIG. 4. Event “Open” 5005 of control flow embodiment 5000 of FIG. 5 corresponds generally to event “Application opens CM-mapped port” 2100 of control flow embodiment 2000 of FIG. 2A. Blocks 5010 and 5015 of control flow 5000 of FIG. 5 correspond generally to blocks 2225 and 2250 of control flow 2300 of FIG. 2B. “Apply Connection Policy” 5075 of control flow 5000 of FIG. 5 corresponds generally to blocks 2325 and 2350 of control flow 2300 of FIG. 2B. Conceptual state “End” 5050 terminates control flow 5000 under several circumstances. During normal operation, state 5050 corresponds to the exit transition 2355 of control flow 2300 of FIG. 2B (which leads to state “Connection Active” 2900 of FIG. 2A). At other times state 5050 corresponds to an abnormal termination of control flow 5000 (which would conceptually lead back to state “No Connection” 2100 of FIG. 2A). The other blocks of control flow embodiment 5000 of FIG. 5 provide for more comprehensive connection behavior than the basic “Apply Connection Policy” 2300 embodiment of FIGS. 2A and 2B.

Upon event “Open” 5005, flow follows path 5006 to action “Read Database CCR matching to the Application” 5010. Flow proceeds via path 5011 to decision “CCR found?” 5015. If at decision 5015 a CCR is found (a DB entry exists), decision “Acceptor?” 5060 is evaluated. If at decision 5060 the Connection Role (discussed below) is that of Acceptor, flow proceeds via path 5061 to action “Add Service in Service Directory DB” 5065, then via path 5066 to action “Listen” 5070, and via path 5071 to state “End” 5050. If at decision 5060 the Connection Role is that of Initiator, flow proceeds from decision 5060 via path 5062 to action “Apply Connection Policy” 5075, and then via path 5076 to state “End” 5050.

If at decision 5015 no CCR is found (no DB entry exists), decision “Is there a default CCR?” 5020 is evaluated. If at decision 5020 there is a default CCR, flow proceeds via path 5022 to action “Apply the Default Connection Policy” 5055, and then via path 5056 to state “End” 5050. If at decision 5020 there is no default CCR, flow proceeds via path 5021 to action “Launch generic discovery” 5025, and then via path 5026 to decision “How many devices?” 5030. If at decision 5030 the number of devices is zero, then flow 5000 abnormally terminates via path 5032 in state “End” 5050. If at decision 5030 the number of devices in one or more, then flow follows path 5031 to action “Display Device Selection” 5035, then via path 5036 to decision “User Choice?” 5040. If at decision 5040 the user cancels device selection, flow 5000 abnormally terminates via path 5042 in state “End” 5050. If at decision 5040 the user chooses one of the devices displayed in action 5035, then flow follows path 5401 to action “Write Database Record” 5045. In certain embodiments action 5045 also performs functions corresponding to blocks 2325 and 2350 of control flow 2300 of FIG. 2B. Flow then proceeds via path 5045 to state “End” 5050.

The Connection Manager Database

The database stores the required information to setup a connection for a specific application. This information is contained in the Connection Configuration Record, (CCR). In a database embodiment, if the application doesn't have an associated record, a default CCR is used. The database contains cache information used for lengthy operation such as Bluetooth device and service discovery.

The database main goals are to make the CCR persistent and to optimize the connection configuration time. In a database embodiment, the database is set using XML script files. In a database embodiment, a UI allows the user to configure a CCR for an application. This UI is accessible through a control panel applet.

The database is organized by location area, by application identification, and by the Connection Manager instance identification. The result is an address to the information in the database such as: area id.application_id.instance_id.

In certain database embodiments, if the location area is not defined or the application is not defined then a default is used. So if nothing is defined the address to the information in the database is: default_area.default application.default_instance. Communication Configuration Record Definition

The CCR in the database includes the following information: Connection Role, Connection Type, Port identification, Device Address, Service Name, Protocol Type, Reconnection Parameters, Services Preference, Opening Mode Type and the Security Key value. These and other CCR information are described in the following paragraphs.

Connection Role: The valid choices for connection role include acceptor and initiator. The initiator role is to initiate a connection and the acceptor role is to open a communication in a server mode.

Connection Type: The connection type defines the communication transport. The valid choices for connection type include wired, Bluetooth, ZigBee, WiFi and other transport.

Port identification: The port identification contains the channel identification. For Bluetooth it is the RFCOMM Channel number, for a wired connection it is the COM port number.

Device Address: The device address contains the address of the remote device for wireless connection type. This field is a characters string type. The device address field is used only is the Connection Manager is used in its initiator role. In certain embodiments, if the connection type is set to wired, the device address is: “COM”.

Service Name: The service name is the name used for the service discovery. If the role is initiator, the service name is used to discover remote device services.

Protocol Type: The protocol type defines which protocol to use. In certain embodiments, the protocol types include one or more of serial, OBEX File Transfer, and OBEX Push.

Connection policies: The connection and reconnection policies define the opening mode if the CCR doesn't have all the required information to establish a connection. The connection policies include: display a device pick dialog, do a remote device search, or search for the first remote device matching to the desired service.

Reconnection polices: The reconnection policies define the reconnection behaviors. The parameters include: the number of active retries, the time between active retries, the number of device watching retries, and the time between device watching retries. The device watching retries are used once the number of active retries is reached then the Connection Manager will try to re-launch the reconnection process to the remote device using the active parameters. This is for spacing the reconnection which is power consuming.

Target device preference: The target device preference defines the target device preference order. In some occasion, an application could use a wired transport in priority of a wireless transport or vice versa. If the target device preference is used, then the target device is defined by a couple or transport type and service name. The list of target device is a semi colon separated couple of transport type and service name. The items of the couple are separated by a coma.

Security Key: The security key is used essentially when the connection type is set for using a wireless transport. If the wireless transport is Bluetooth the security key is the Pin key.

Configuration File Name: In certain embodiments, the configuration file name identifies a XML configuration file that is used if no parameter has been set. This field is optional and may be left empty. If a file name is provided and the other connection configuration parameters aren't set, then the XML configuration file is parsed and run as a script file to configure the CCR.

Configuration File Name Date: A Configuration File Name Date is used to store the last modification date of the configuration file name. If the date is recent then it will use the XML file, specified by the configuration file name field, to reconfigure the record.

Parsing Flags: The parsing flags tells the Connection Manager if it needs to parse the associated XML file before opening a connection.

Security Flags: The Security Flags define the type of protection for the CCR record. Some operations that modify the CCR are protectable by password.

Security Password: This is a characters string containing an encrypted password. Depending on the Security Flags the CCR modifications are password protected.

Reference Mechanism of a CCR

The CCR is referenced by 3 levels: the location area reference, the application area and the interface instance.

Location Area Reference: The first level concerns the location area. Depending on where the device is, it could have a different connection setting. A default is used in cases where either the location area reference is not detected or not provided. The location area is detected by the presence of wireless device that could identify a location, i.e. a Wireless GPS that usually sits in a car could define a “Car” location area, a Bluetooth USB adapter plugged into the office workstation could define the “office” location.

Application Reference: The application reference is used by the Connection Manager to connect the application to the right device. The Connection Manager could use the same COM port for several applications. Each applications opening the Connection Manager COM port potentially will be connected to different device. This feature is especially useful where few COM number is available.

A default application reference is used when the application is not identified in the database.

The Connection Manager Instance reference: The Instance reference allows an application to open several time the Connection Manager COM port to connect to different devices. For each instance a CCR defines the connection configuration. In certain embodiments, if the instance doesn't matter to the application, a default instance reference is used and the same connection configuration is applied to the subsequent connection made by the application.

Cache Feature

The database has a cache feature that is used for optimizing lengthy operation such as a Bluetooth device and service discovery.

Services provided by the Connection Manager Database

The services provided by the Connection Manager to the outside world are: Create the Database, Delete the Database, Add, Remove Read and Write a Record in the Database.

The Connection Manager Virtual COM Port

The Connection Manager provides one or more regular serial COM port interfaces called virtual COM ports. The virtual COM port provides the same services than a classical COM port. They are virtual in a sense that they are not directly connected to a piece of hardware. This virtual COM port allows software to connect to a remote device using the regular COM port API provided by the OS.

The Connection Manager manages the connection configurations and policies for each application. Depending on the application opening the virtual COM Port, the Connection Manager searches the CCR matching to the application and applies the settings to create the appropriate connection.

In certain embodiments, an XML file is used to configure the connection parameters for a particular application. The details of the XML format are discussed elsewhere herein.) The virtual COM port provides a connection process, a reconnection process, the serial communications services, and some extended features enabling Applications using some specific the Connection Manager services such as device discovery service, read a remote device address to name a few.

Connection Process

An application is opening the Connection Manager virtual COM port. The Connection Manager looks in its database for the appropriate CCR. The database CCR uses a reference to a location area, (this feature is not activated so it uses the default location), a reference to an application identification and a reference on the instance number the application is opening the Connection Manager virtual COM port. If it couldn't find a CCR matching to this application then it takes the CCR associated to the default application id. This default CCR searches for an XML file corresponding to the opening application. If this XML file doesn't exist then it uses the default settings present in this CCR. If the application XML file exists it parses it and executes the steps described. Once the connection is established and depending on the connection policy the Connection Manager stores the connection configuration parameter in the CCR matching to the application. The next open made by this application, will cause the Connection Manager to read the associated record and performs what the CCR has been set in the previous open.

If the database CCR contains all the necessary information then the next step depends of the client role. If the client role is acceptor, then a service record is added into the service discovery database. Once the service discovery record is added, the listen operation is invoked and waits for an incoming connection. If the client role is initiator then it applies the connection policy.

The connection could launch a device and service discovery, it could ask the user to select one device from a list. For more details see the policies description down below. This Open function returns a handle on the serial port to identify the client. This handle is provided for each subsequent serial port function calls.

Connection Policies

The Connection Manager defines a set of connection policies described in the following Connection Policies Table. The connection policy definition has its own field in the CCR.

TABLE 1
Connection Policies

| | |
|---|---|
| Discover policy | launches a device discovery using the Service Name to filter the result. |
| | The Connection Manager takes the first device returned from this |
| | discovery and tries to connect to it. If no device is found it returns an |
| | error. |
| DiscoverAndStore policy | does the same thing than the Discover policy but it stores the result in |
| | the appropriate database CCR. The CCR is associated to the |
| | application launching the connection process. |
| DiscoverSelect policy | does the same thing than the Discover policy but in case there are |
| | several devices found, it will ask the user to select from a list. If the |
| | user cancels this selection, the Connection Manager terminates the |
| | connection process with an error code. |
| DiscoverSelectAndStore | does the same thing than the DiscoverSelect policy but the device to |
| | which the connection is successfully made is stored in the database to |
| | the CCR matching to the application initiator of the connection |
| | process. |
| Set policy | sets the connection configuration parameters in the CCR associated to |
| | an application. If the connection process can't connect to the remote |
| | device then it returns an error. |
| SetOrDiscover | does the same thing than the Set policy but if the connection process |
| | can't connect to the remote device it will apply the Discover policy |
| | described above. The connection process will connect then to the first |
| | device found. The actual settings in the CCR are not updated with the |
| | new device information. |
| SetOrDiscoverAndStore | does the same thing than the Set policy but if the connection process is |
| | unsuccessful it will apply the DiscoverAndStore policy. If the final |
| | connection went through successfully then the new device information |
| | is stored in the database. The next connection will use this information. |
| SetOrDiscoverSelect | does the same thing than the Set policy but if the connection process is |
| | unable to connect to the remote device, it will apply the DiscoverSelect |
| | policy. The user may have to select the device if more than one device |
| | is found. The actual settings in the CCR are not updated with the new |
| | device information. |
| SetOrDiscoverSelectAndStore | does the same thing the Set policy but if the connection process is |
| | unable to connect to the remote device, it will apply the |
| | DiscoverSelectAndStore. If the connection is successful then the new |
| | device information is stored in the CCR matching to the opening |
| | application. |

Shared Connection

In certain embodiments a ShareConnection policy is added to the foregoing connection policies. The ShareConnection policy is used to share an existing connection established by a previous open made within the same application. The following scenario describes how an application applies the ShareConnection policy: An application opens the Connection Manager gateway port a first time. The Connection Manager applies the right scenario and establishes a connection to the appropriate remote device. The same application subsequently opens the Connection Manager gateway port a second time in a different thread. This thread is, in this scenario, often used to watch the status of the communication link. The Connection Manager detects the same application is opening twice its gateway port, and applies the settings for this second open. In this case, the active ShareConnection policy tells the Connection Manager to share the previously established connection. Thus, under the ShareConnection policy the Connection Manager does not attempt to create a new connection, but instead re-uses the previous connection.

Reconnection Process

The reconnection process starts when the Connection Manager receive a disconnection notification from either a device suspend resume notification or from the transport layer because the link is broken with the remote device.

The reconnection process then could have different phases. The Sleep phase causes the Connection Manager to sleep before retrying a connection using the last CCR settings. This phase has 2 parameters, the number of milliseconds to sleep, and the number of retries. The Discovery phase starts a discovery as it is defined in the CCR. The notification phase notifies the application about the disconnection.

The phases used in the reconnection process are defined by the reconnection policy present in the CCR. During the reconnection process the application is not aware the link is broken, unless the reconnection policy notifies the application right away.

During the reconnection process the data sending process is on hold. The application using the Connection Manager COM port is blocked during the data writing. Data are sent as soon as the connection is re-established. The disconnection notification sent to the application will cause all the pending action to be aborted.

Legacy COM Port Functions

The entire set of COM port functions are working as described in their current specifications. These functions are: Get/SetCommState, Get/SetCommMask, Get/SetCommTimeouts, Clear/SetCommBreak, ClearCommError, EscapeCommFunction, GetCommModemStatus, SetupComm, TransmitCommChar, Read, Write, WaitCommEvent, PurgeComm.

Extended Features

The Connection Manager provides a set of extended features enabling application to configure the Connection Manager, to retrieve information such as the remote device information, the CCR used for the current application. In certain embodiments, the extended features exist in 5 groups.

This feature sets the parameters required to connect to a remote device. The parameters are saved in a CCR. As described before, the CCR contains the role of the device, the address of the remote device, the desired service of the remote device, discovery information, the protocol used for the communication. The only access to a CCR is by using IO control calls through The Connection Manager virtual COM port interface as described elsewhere herein. In certain embodiments, the settings are set by subsequent IO control calls. In other embodiments, the settings are set by using an XML file to preset the CCR to factory values. The XML file describes the CCR. It can be thought of as a script file capable of launching some operations to complete the missing or variable information such as a device and service discovery. The Connection Manager virtual COM port interface provides a set of functions for discovering devices and services, to provide a UI to the user to select the appropriate remote device, set a favorite remote device for a specific port interface.

The client software using The Connection Manager virtual COM interface opens first the interface that will return a unique handle. Then, the client software uses the Connect IO Control function call to really initiate the connection. Prior this call, the client software could interrogate the database using the database access IO control functions, to retrieve information or to set information before the connection process.

Notification on communication events: In certain embodiments, the Connection Manager virtual COM port interface client software is notified on communication events. The connection events available are the same as a regular COM port interface plus the following events:
device suspend-resume
disconnection from the remote device (i.e. remote device disconnects)
disconnection of the transport (i.e. Bluetooth out of range)
New Device notification
Remove Device notification
Connection request (i.e. a remote device connects, used when The Connection Manager virtual COM port is open as acceptor)
Configuration Services: The Connection Manager virtual COM port interface provides access to the database to configure a connection. There are four functions provided: read CCR, write CCR, Is CCR completed, Configure CCR with XML file.

In certain embodiments, the Configuration Services are used to perform device and service discovery. Implementations options include asking the user to choose a device and service from a list or automatically choose the more appropriate device without any user intervention.

In certain embodiments, the Configuration Services are used to retrieve the number of instance and their identification for each interface COM. This feature gets the list of interfaces available in the device. For each interface a status is returned to know if the interface is opened and by whom.

TABLE 2
Configuration Services

| | |
|---|---|
| ReadCcr | returns the CCR matching to the application id passed as input parameter. |
| | If the application doesn't have an associated CCR it returns the default |
| | CCR. If there is no default CCR then an error is returned. |
| WriteCcr | allows an application to write a CCR for a specific application. The |
| | application id and the new CCR are passed as input parameter. An error |
| | code is returned in case of failure. |
| IsCcrCompleted | checks is a CCR matching to the application id passed as input parameter |
| | is complete enough to make a connection. This function returns true or |
| | false depending on the state of the CCR record. If the application doesn't |
| | have a CCR associated, then the default record is used. If there is no |
| | default CCR then false is returned. |
| ConfigureCcrWithXmlFile | configures a CCR from the content of an XML file which the file name is |
| | passed as input parameter. If the CCR doesn't exist for the associated |
| | application, then this function creates a new CCR and matches it to the |
| | application concerned. If the application has a CCR present in the |
| | database, depending on the setting in the XML file it could overwrite the |
| | previous CCR settings. |
| GetCcrList | returns the list of CCR present in the database. The database is locked until |
| | the ReleaseCcrList is called. |
| ReleaseCcrList | releases the list of CCR. If the modification flags is set then is update the |
| | database with the changes made in this list. It unlocks the database. |
| AddCcr | adds a new CCR in the database matching to the application id passed as |
| | input parameter. |
| RemoveCcr | removes a CCR from the database matching to the application id passed as |
| | input parameter. |

Transport Services: The transport services regroups all the services that are in relation with the transport layer. Each transport is identified by a type.

TABLE 3
Transport Services

| | |
|---|---|
| Discover | launches the discovery of remote devices. The parameter of the discovery |
| | allows filtering and discovering only specific devices. The type of transport |
| | is passed as input parameter as well. The result is a list of device address and |
| | services. |
| ReadPortList | returns the list of virtual COM port mounted by the Connection Manager. |
| AddPort | asks the Connection Manager to mount a new virtual COM port. |
| RemovePort | asks the Connection Manager to un-mount a virtual COM port specified with |
| | its COM port number passed as input parameter. The Connection Manager |
| | requires at least one virtual COM port. This virtual COM port can't be |
| | removed. |
| ReadCurrentLocation | returns the current location detected by the Connection Manager. |
| WriteCurrentLocation | sets the current location. |
| DiscoverCurrentLocation | launches the discovery of the current location. |
| ReadTransportList | returns the list of available transport. The transport may be any of several |
| | Bluetooth stacks or Serial ports. Each transport type has a major type (such |
| | as Bluetooth, Serial, WiFi) and a subtype giving an indication of the |
| | transport provider. |

UI Services: The Connection Manager can offer its own UI for applications using it. Here is the list of UI services:

TABLE 4
UI Services

| | |
|---|---|
| ReadUserSelection | creates a dialog box allowing a user selection. There is a multi |
| | purpose list passed as input parameter. |
| CancelUserSelection | allows an application to cancel a user selection dialog. |
| StartDisplayProgressDialog | starts a dialog with a progression indication. |
| StopDisplayProgressDialog | stops the progression dialog. |
| CallbackDisplayProgressDialog | Once the progression dialog is terminated either because it was |
| | cancelled or because the timeout elapsed a callback is called. This |
| | service blocks the caller until the callback is effectively called. |
| DisplayFavoriteSettingsDialog | causes the Connection Manager to display its favorite dialog. The |
| | favorite dialog allows a user to change the settings for each |
| | application recognized by the Connection Manager. |

File Transfer Services: In certain embodiments, the File Transfer services create a set of function using The Connection Manager COM port interface to send and receive file using the OBEX File Transfer protocol. The functions are the following: start FTP Server, stop FTP Server, Set Local Root Path, Set Remote Path, Get File, Push File, Delete File, Rename File, Get Directory Content.

The Connection Manager UI Definition

The UI in the Connection Manager is necessary when the CCR doesn't have all the information required to establish a connection, or when an operation is too long and the user needs to be notified that a process is in progress.

The UI is mainly used to drive the device and service discovery. There are three source initiators of UI: the Connection Manager during its process of connection, an external configuration utility (located in the control panel of certain embodiments), and the installation setup program.

The UI is implemented in a separate module that is invoked by the Connection Manager itself, by a control panel applet, or by a setup program. The UI preferably is not tied to a specific transport technology. Each UI dialogs is controlled by API functions.

Operation in Progress

A UI screen could appear to invite the user to wait for the lengthy operation to complete. This screen displays an animation to show the operation is in progress and a cancel button to abort the process. If the user cancels the operation then the result available (if any) will be returned with no error. If there is no result returned then the discovery process then an error will be returned. A descriptive text is displayed to show the user what operation is in progress. The API for this dialog has two functions: a Start function with the descriptive text, a title text, a flag value and a timeout value in parameter, and a Stop function. The Start function displays the dialog with the text and animation. The parameters contain the descriptive text, and a callback function to be called when the dialog is cancelled or stopped. The Stop function clears the dialog. In certain embodiments, the dialog is canceled by the user with the cancel button. The Stop function and the user cancellation cause the callback passed in the Start function parameter to be called. A return code specifies how the dialog is closed, by user cancellation or by the Stop function. If the callback parameter is null in the Start function then the Cancel button won't appear on the dialog.

Pick List Dialog Box

The Pick list dialog box displays a screen to let the user choose an item from a list. In certain embodiments, this item is a remote device and a service the connection should be established with. This screen offers four options to the user. The first option is to simply select the device and service, the second option is to save the user selection as favorite, so the next connection will not ask the user for a device and service selection unless the saved configuration is not able to complete the connection. The third option is to refresh the device and service list. This option is useful if the remote device wasn't ready for the discovery. The fourth option gives the user the opportunity to cancel the current operation. There are 2 APIs to control the Pick Dialog box UI. The ReadUserSelection function allows software to give a list of items the user needs to choose, an option flag to configure the dialog box and a descriptive text. In certain embodiments, the configuration of the dialog box includes a cancel button and a “save selection as favorite choice” list. The user selects one item in the list and hits the OK button to validate his or her choice. The choice is then identified in the items list. This function will return a value regarding the user action. A cancel function, CancelUserSelection allows software to interrupt the operation for whatever reason. This API doesn't have parameter. In certain embodiments, the Pick List dialog box has a sorting feature. The sort has several criteria including name order and type order.

Favorite Settings Dialog Box

The favorite settings dialog box gives the user the opportunity to pre-configure each interface provided by the Connection Manager. The dialog box proposes to select the port interface and then an application or default for no application in particular. For the selected port interface the user can start a device service discovery to complete the CCR field such as device address, the port type etc . . . . The user has the possibility to change the service name. The user may reset all the parameters or launch a configuration scripting process by using a file open dialog to search for the XML configuration file. The XML file is then be parsed and played as a script file by the Connection Manager. This screen will also display the Connection Manager version number, the preferred communication stack if several stacks are available in the device. The favorite settings dialog is organized in tab screens. The tab general displays version information, and the communication stack preference in case of the presence of several stack in the device, and the number of interfaces that are instantiated. Depending on this number of interface instantiations, a tab for each of this instantiations is created. The screen for an interface instantiation let the user to see and modify the parameters for this particular instance. A default interface instantiation tab is created for each interface type. These default tabs will set the default configuration in case the other instantiation tabs aren't configured.

For each instance tab the information displayed and user inputs are:

Connection Role,

Connection Type,

Port identification,

Device Address, with a button to launch a device and service discovery,

Service Name,

Protocol Type,

Reconnection Parameters,

Connection Type Preference,

Operational Mode Type,

Security Key,

Configuration File Name.

To control the favorite settings dialog box UI two API are used. The DisplayFavoriteSettings that displays a dialog box allowing the user to change his or her favorite. The CancelFavoriteSettings allows to software to make the favorite settings dialog UI disappears.

XML Configuration File

The XML configuration file is used to setup the CCR database with factory settings. XML format The XML configuration file has the following format:

| | |
|---|---|
| 1 | <?xml version=”1.0” ?> |
| 2 | <connecttionmanager version=”1.0”> |
| 3 | <-- give the stack preference order in case of several identical communication stack--> |
| 4 | <stackPreferenceOrder type=”Bluetooth”>[value]</stackPreferenceOrder> |
| 5 | <-- typical sample to set a CCR --> |
| 6 | <ccr policy=”set” interface=”COM” location=”default” application=”default” |
| 7 | instance=”default” method=”no overwrite”> |
| 8 | <connectionRole>[value]</connectionRole> |
| 9 | <connectType>[value]</connectType> |
| 10 | <portIdentification>[value]</portIdentification> |
| 11 | <deviceAddress>[value]</deviceAddress> |
| 12 | <serviceName>[value]</serviceName> |
| 13 | <protocolType>[value]</protocolType> |
| 14 | <reconnectionParameters>[value]</reconnectionParameters> |
| 15 | <typePreference>[value]</typePreference> |
| 16 | <operationalModeType>[value]</operationalModeType> |
| 17 | <securityKey>[value]</securityKey> |
| 18 | <configurationFileName>[value]</configurationFileName> |
| 19 | </ccr> |
| 20 | <-- typical sample to discover a CCR as soon as this file is parsed--> |
| 21 | <ccr policy=”discover” interface=”COM” location=”default” application=”default” |
| 22 | instance=”default” method=”overwrite”> |
| 23 | <connectionRole>[value]</connectionRole> |
| 24 | <connectType>[value]</connectType> |
| 25 | <portIdentification>[value]</portIdentification> |
| 26 | <deviceAddress>[value]</deviceAddress> |
| 27 | <serviceName>[value]</serviceName> |
| 28 | <protocolType>[value]</protocolType> |
| 29 | <reconnectionParameters>[value]</reconnectionParameters> |
| 30 | <typePreference>[value]</typePreference> |
| 31 | <operationalModeType>[value]</operationalModeType> |
| 32 | <securityKey>[value]</securityKey> |
| 33 | <configurationFileName>[value]</configurationFileName> |
| 34 | </ccr> |
| 35 | </connectionmanagert> |
| 36 | |

As shown in the format above the CCR tag has an attribute to identify the operation type. The CCR has 2 operation types, set and discover. The set type is used to set each field of the CCR. The Discover will initiate a device and service discovery. The discovery will use some of the CCR field to know what to look for, and in case of failure the values that are already defined in the field are applied.

### CONCLUSION

Although the foregoing embodiments have been described in some detail for purposes of clarity of understanding, the invention is not limited to the details provided. There are many ways of implementing the invention. The disclosed embodiments are illustrative and not restrictive.

It will be understood that many variations in construction, arrangement and use are possible consistent with the teachings and within the scope of the claims appended to the issued patent. For example, interconnect and function-unit bit-widths, clock speeds, and the type of technology used may generally be varied in each component block. The names given to interconnect and logic are merely illustrative, and should not be construed as limiting the concepts taught. The order and arrangement of flowchart and flow diagram process, action, and function elements may generally be varied. Also, unless specifically stated to the contrary, the value ranges specified, the maximum and minimum values used, or other particular specifications (such as the quantity, type, and speed of processors and memory; interface bandwidths; the degree of redundancy for any particular component or module; the particular version of an interface standard or component; and the number of entries or stages in registers and buffers), are merely those of the illustrative embodiments, may be expected to track improvements and changes in implementation technology, and should not be construed as limitations.

Functionally equivalent techniques known to those of ordinary skill in the art may be employed instead of those illustrated to implement various components, sub-systems, functions, operations, routines, and sub-routines. It is also understood that many design functional aspects may be carried out in either hardware (i.e., generally dedicated circuitry) or software (i.e., via some manner of programmed controller or processor), as a function of implementation dependent design constraints and the technology trends of faster processing (which facilitates migration of functions previously in hardware into software) and higher integration density (which facilitates migration of functions previously in software into hardware). Specific variations may include, but are not limited to: differences in partitioning; different form factors and configurations; use of different operating systems and other system software; use of different interface standards, network protocols, or communication links; and other variations to be expected when implementing the concepts taught herein in accordance with the unique engineering and business constraints of a particular application.

The embodiments have been illustrated with detail and environmental context well beyond that required for a minimal implementation of many of aspects of the concepts taught. Those of ordinary skill in the art will recognize that variations may omit disclosed components or features without altering the basic cooperation among the remaining elements. It is thus understood that much of the details disclosed are not required to implement various aspects of the concepts taught. To the extent that the remaining elements are distinguishable from the prior art, components and features that may be so omitted are not limiting on the concepts taught herein.

All such variations in design comprise insubstantial changes over the teachings conveyed by the illustrative embodiments. It is also understood that the concepts taught herein have broad applicability to other computing and networking applications, and are not limited to the particular application or industry of the illustrated embodiments. The invention is thus to be construed as including all possible modifications and variations encompassed within the scope of the claims appended to the issued patent.

What is claimed is:

1. A method to establish a communications link between at least one application and at least one device, the method comprising:
establishing a database of applications and associated devices and communication ports;
detecting an application attempting to initiate communications;
transparent to the application, identifying the application;
further transparent to the application, configuring and managing the communication port associated with the application; and
establishing the communications link between the application and the device associated with the application.

2. The method of claim 1, wherein the communication port associated with the application is one of: a serial COM port, a parallel port, a wireless port, a USB port, a Firewire port, a TCP/IP port, a TCP/IP socket, and a communications channel.

3. The method of claim 1, wherein the device is one of: a barcode scanner, an RFID scanner, a magstripe reader, a modem, a telephone, a GPS receiver, a serial device, a parallel device, a network device.

4. The method of claim 1, wherein the device is one of: a WiFi device, a Bluetooth device, a UWB device, a ZigBee device, a GSM device, a CDMA device, a TDMA device, and GPRS device, and an Ethernet device.

5. The method of claim 1, wherein opening the communications port associated with the application results in execution of a predetermined connection policy.

6. The method of claim 1, wherein a predetermined reconnection policy is executed upon disconnection of the device associated with the application.

7. The method of claim 1, wherein the communication port associated with the application is legacy serial port compatible.

8. A system for use by one or more applications, comprising:
a connection manager subsystem having an associated communication port management database;
a shared gateway communication port, adapted to:
communicate with the connection manager subsystem, and be opened by at least one of the applications;
wherein each application opening the shared gateway communication port causes a lookup in the database; and
wherein if the lookup result returns an entry associated with the application, the connection manager subsystem configures an entry-specified communication port in accordance with the entry and establishes a communications link between the application and an entry-specified device via the entry-specified communication port.

9. The system of manufacture of claim 8, further wherein if the lookup result returns no entry associated with the application, the connection manager subsystem establishes a communications link between the application and a device coupled to an application-specified port.

10. The system of claim 8, wherein the entry-specified communication port is one of: a serial COM port, a parallel port, a wireless port, a USB port, a Firewire port, a TCP/IP port, a TCP/IP socket, and a communications channel.

11. The system of claim 8, wherein the entry-specified device is one of: a barcode scanner, an RFID scanner, a magstripe reader, a modem, a telephone, a serial device, a parallel device, a network device.

12. The system of claim 8, wherein the entry-specified device is one of: a WiFi device, a Bluetooth device, a UWB device, a ZigBee device, a GSM device, a CDMA device, a TDMA device, and GPRS device, and an Ethernet device.

13. The system of claim 8, wherein the lookup uses a search key that includes an application identifier.

14. The system of claim 8, wherein if no entry is returned by the lookup, the connection manager attempts to create a new entry.

15. The system of claim 14, wherein the new entry is created with user participation.

16. The system of claim 8, wherein the database entries for each application include information about a preferred device, the communication port the preferred device is connected to, and how to configure the communication port.

17. The system of claim 8, wherein the gateway port has one type of the types including: virtual port type and physical port type.

18. The system of claim 8, wherein the gateway port has one type of the types including: legacy serial port, USB port, a Firewire port, a parallel port, a wireless port, a TCP/IP port, a TCP/IP socket, and a communications channel.

19. An article of manufacture, which comprises a computer readable medium having stored therein a computer program component adapted to be communicated with by one or more applications, the computer program component comprising:
a first code segment, which when executed on a computer, instantiates a connection management subsystem having an associated communication port management database; and
a second code segment, which when executed on a computer, instantiates a shared gateway communication port adapted to communicate with the connection management subsystem and further adapted to be opened by the one or more applications;
wherein each application opening the shared gateway port causes a lookup in the database; and
wherein if the lookup result returns an entry associated with the application, the entry specifying a device and a communication port, the connection manager configures the entry-specified port in accordance with the entry and establishes a communications link between the application and an entry-specified device via the entry-specified port.

20. The article of manufacture of claim 19, further wherein if the lookup result returns no entry associated with the application, the connection manager establishes a communications link between the application and a device coupled to an application-specified port.

21. The article of manufacture of claim 19, wherein the entry-specified communication port is one of: a serial port, a parallel port, a wireless port, a USB port, a Firewire port, a TCP/IP port, a TCP/IP socket, and a communications channel.

22. The article of manufacture of claim 19, wherein the entry-specified device is one of: a barcode scanner, an RFID scanner, a magstripe reader, a modem, a telephone, a serial device, a parallel device, a network device.

23. The article of manufacture of claim 19, wherein the entry-specified device is one of: a WiFi device, a Bluetooth device, a UWB device, a ZigBee device, a GSM device, a CDMA device, a TDMA device, and GPRS device, and an Ethernet device.

24. A computer data signal embodied in a transmission medium, the computer data signal propagating a computer program component adapted to establish a communications link between at least one application and at least one associated communications device, the computer program component comprising:
a first code segment, which when executed on a computer, establishes a database of applications, each application in the database having at least one entry, each entry specifying an associated communication port and an associated device;
a second code segment, which when executed on a computer, attempts a lookup in the application database of at least some applications attempting to initiate communications;
a third code segment, which when executed on a computer, when the lookup finds an entry in the database, configures and manages the associated communication port device, the configuration and management being transparent to the application; and
a fourth code segment, which when executed on a computer, when the lookup finds an entry corresponding to the application in the database, establishes a communication link between the application and the associated device.

25. The computer data signal embodied in a transmission medium of claim 24, further including a fifth code segment, which when executed on a computer, when the lookup finds no entry corresponding to the application in the database, establishes a communication link between the application and a device coupled to an application-specified port.

26. The computer data signal embodied in a transmission medium of claim 24, wherein the entry-specified communication port is one of: a serial port, a parallel port, a wireless port, a USB port, a Firewire port, a TCP/IP port, a TCP/IP socket, and a communications channel.

27. The computer data signal embodied in a transmission medium of claim 24, wherein the entry-specified device is one of: a barcode scanner, an RFID scanner, a magstripe reader, a modem, a telephone, a serial device, a parallel device, a network device.

28. The computer data signal embodied in a transmission medium of claim 24, wherein the entry-specified device is one of: a WiFi device, a Bluetooth device, a UWB device, a ZigBee device, a GSM device, a CDMA device, a TDMA device, and GPRS device, and an Ethernet device.
